(19) United States
(12) Patent Application Publication
(10) Pub. No.: US 2022/0309940 A1
(43) Pub. Date: Sep. 29, 2022

(54) AUTOMATIC SCORING METHOD, SERVER, AUTOMATIC SCORING SYSTEM AND RECORDING MEDIUM

(71) Applicant: CASIO COMPUTER CO., LTD., Tokyo (JP)

(72) Inventor: Manato ONO, Tachikawa-shi (JP)

(73) Assignee: CASIO COMPUTER CO., LTD., Tokyo (JP)

(21) Appl. No.: 17/683,752

(22) Filed: Mar. 1, 2022

(30) Foreign Application Priority Data
Mar. 24, 2021 (JP) 2021-049644

(51) Int. Cl. G09B 7/04

(52) U.S. Cl. CPC G09B 7/04; G09B 19/025

(57) ABSTRACT

An automatic scoring method by processor includes receiving information including an answer to a question, scoring the answer according to one or more evaluation items preset for the question, and visually distinguishing a result of the scoring in accordance with an evaluation item that has matched the answer.

### CROSS-REFERENCE TO RELATED APPLICATION

This application is based upon and claims the benefit of priority from Japanese Patent Application No. 2021-049644, filed Mar. 24, 2021, the entire contents of which are incorporated herein by reference.

### FIELD

The present disclosure relates generally to an automatic scoring method, a server, an automatic scoring system and a recording medium.

### BACKGROUND

Online classes have been introduced in recent years. In the online classes, for example, examinations are also conducted online. A system capable of automatic scoring for the examinations has been proposed (Jpn. Pat. Appln. KOKAI Publication No. 2019-61189).

### SUMMARY

An automatic scoring method by processor of an aspect includes receiving information including an answer to a question, scoring the answer according to one or more evaluation items preset for the question, and visually distinguishing a result of the scoring in accordance with an evaluation item that has matched the answer.

### BRIEF DESCRIPTION OF THE DRAWINGS

FIG. 1 is a block diagram showing an example of a configuration of a system according to an embodiment of the present disclosure.

FIG. 2 is a diagram showing an example of screen display of an application running on a web browser of a terminal.

FIG. 3 is a sequence chart showing an example of the operation of the system performed when answer papers for examinations or the like are prepared.

FIG. 4A is a diagram showing an example of a dialog displayed on a paper.

FIG. 4B is a diagram showing an example of a dialog displayed on a paper.

FIG. 4C is a diagram showing an example of a dialog displayed on a paper.

FIG. 5 is a sequence chart showing an example of the operation of the system performed when a question is answered.

FIG. 6 is a diagram showing an example of a display screen of a terminal 20b on which an answer paper is displayed.

FIG. 7 is a sequence chart showing an example of an operation performed when scoring is made.

FIG. 8 is a flowchart showing an example of a process of a server performed when automatic scoring is made.

FIG. 9 is a diagram showing an example of a screen of a terminal 20a on which a paper of automatic scoring results is displayed.

FIG. 10 is a diagram showing an example of a screen of the terminal on which a paper of automatic scoring results in English is displayed.

### DETAILED DESCRIPTION

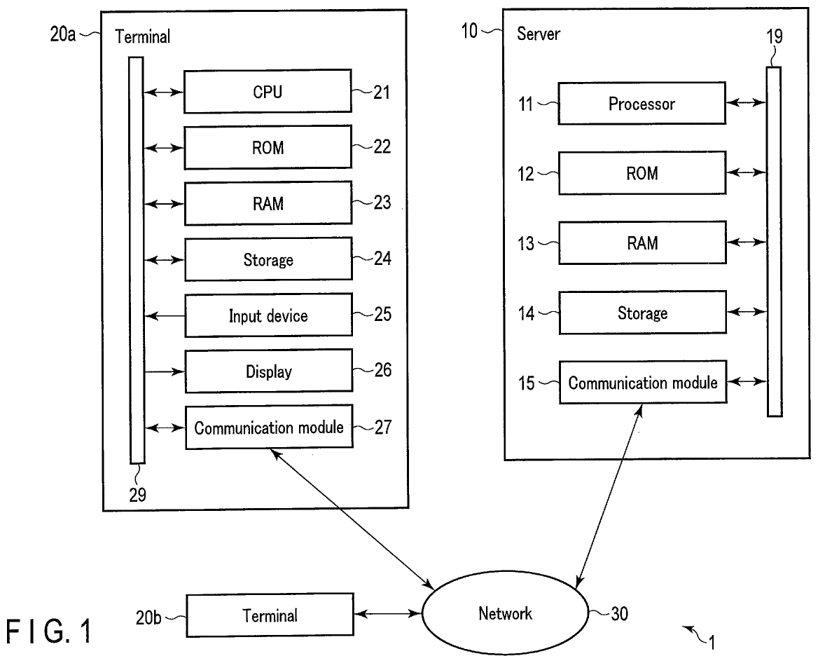

One embodiment of the present disclosure will be described with reference to the drawings. FIG. 1 is a block diagram showing an example of a configuration of a system 1 according to the embodiment of the present disclosure. The system 1 includes a server 10 and terminals 20a and 20b. The server 10 and terminals 20a and 20b are communicably connected via a network 30. The network 30 is, for example, the Internet. The number of terminals is not limited to two. The system 1 has only to include at least one terminal 20a and at least one terminal 20b.

The server 10 includes a processor 11, a ROM 12, a RAM 13, a storage 14 and a communication module 15. These are connected to each other via a system bus 19.

The processor 11 may be an integrated circuit including a central processing unit (CPU) and the like. The ROM 12 records information for use in operating the processor 11 and the like. The RAM 13 is a main storage device to operate the processor 11 and the like. The storage 14 stores various programs such as server control programs used in the processor 11 and arithmetic operation programs for performing various arithmetic operations, parameters and the like. The server control programs include an automatic scoring program. The processor 11 controls the operation of the server 10 in accordance with the programs stored in the storage 14. As the processor 11, a processor other than the CPU, such as an application specific integrated circuit (ASIC), a field programmable gate array (FPGA) and a graphic processing unit (GPU) may be used. The communication module 15 includes a circuit that communicates with an external communication network such as the network 30.

The terminals 20a and 20b may be electronic devices such as a personal computer (PC), a tablet and a smartphone. The terminals 20a and 20b may also be scientific calculators having a communication function. The terminal 20a is operated by an examination marker such as a teacher. The terminal 20b is operated by an examinee such as a student. The configuration of the terminal 20a will be described on the assumption that the terminal 20a has the same configuration as that of the terminal 20b. In the following descriptions, the marker may be distinguished as a first user from the examinee as a second user when necessary.

The terminal 20a includes a CPU 21, a ROM 22, a RAM 23, a storage 24, an input device 25, a display 26 and a communication module 27. These are connected to each other via a system bus 29. Note that the terminals 20a and 20b do not necessarily have the same configuration.

The CPU 21 is a processor that controls various operations of the terminal 20a. The ROM 22 records a start program or the like of the terminal 20a. The RAM 23 is a main storage device for the CPU 21 and the like. The storage 24 stores various programs such as a terminal control program used in the CPU 21, parameters and the like. The CPU 21 controls the operation of the terminal 20a by executing various programs in response to an input signal from the input device 25 and a reception signal from the communication module 27. The programs may be downloaded from a web server (not shown) into the storage 24 via the network 30 and the communication module 27. The communication module 27 includes a circuit to communicate with an external communication network such as the network 30.

The input device 25 includes a keyboard, a mouse, a touch panel and the like. In response to a user's operation performed via the input device 25, a signal indicating the contents of the user's operation is input to the CPU 21 via the system bus 29.

The display 26 is, for example, a liquid crystal display and an organic EL display. The display 26 may be provided integrally with the terminal 20a or may be provided separately from the terminal 20a. Various images are displayed on the display 26.

As one example, a user designates the address of the server 10 in a web browser running on the terminal 20a. At this time, a display screen for a web application stored in the server 10 is displayed on the web browser on the terminal 20a. A request is issued to the server 10 in response to an operation to be performed through the input device 25 on the display screen. This operation includes, for example, an operation related to the scoring of an examination taken by the user of the terminal 20b. The server 10 performs a process corresponding to the request and returns a result of the process to the terminal 20a as a response. In response from the server 10, the terminal 20a makes displays or the like which corresponds to the user's operation. The system 1 thus achieves a function as a web application for examinations and the like based on a program running on the web browser of the terminal 20a and an arithmetic operation program of the server 10. Similarly, the system 1 achieves a function as a web application for examinations and the like based on a program running on the web browser of the terminal 20b and an arithmetic operation program of the server 10.

The web application can be used in, for example, mathematics classes in school education where information and communication technology (ICT) is increasingly developing.

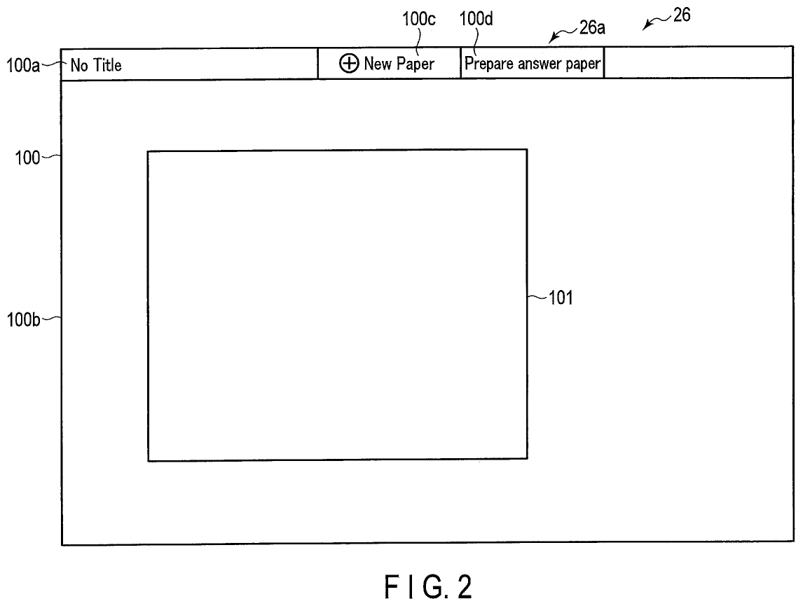

FIG. 2 is a diagram showing an example of screen display of an application running on the web browser of the terminal 20a.

The screen 26a displayed on the display 26 of the terminal 26a includes an upper stage area 100a and a lower stage area 100b. The upper stage area 100a is displayed on the upper side of the screen 26a. The upper stage area 100a is narrower than the lower stage area 100b. A new paper preparation icon 100c is displayed in the upper stage area 100a. An answer paper preparation button 100d is displayed in the upper stage area 100a. The lower stage area 100b is located below the upper stage area 100a in the screen 26a. Hereinafter, the lower stage area 100b will also be referred to as paper 100. Various types of “sticky note” 101 may be displayed on the paper 100. The sticky note 101 is a display area for displaying various items of information concerning the web application. For example, the sticky note 101 includes a mathematical sticky note for creating a numerical expression, a graph sticky note for creating a graph, a table sticky note for creating a table, a figure sticky note for creating a figure, and a comment sticky note for making comments, and the like. The sticky note 101 may be a floating object. The floating object is an object (display body) to be displayed on the screen, and at least the display position thereof can be changed in response to user operation.

In the present embodiment, the system 1 can create various types of sticky note starting from a blank sheet of paper 100. Note that the same paper 100 can be displayed on the terminal 20b as that on the terminal 20a. However, the answer paper preparation button 100d may not be displayed on the paper 100 of the terminal 20b.

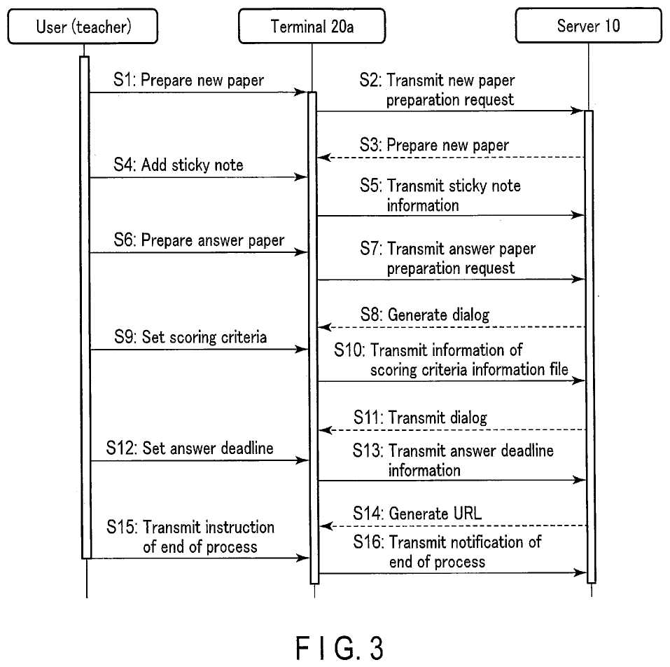

Below is a description of a flow of a series of steps in the system 1. FIG. 3 is a sequence chart showing an example of the operation of the system 1 performed when answer papers for examinations or the like are prepared. Assume here that the first user such as a teacher has prepared questions and a scoring criteria to the questions prior to the process shown in FIG. 3. The scoring criteria to the questions are stored in the server 10 as a scoring criteria information file. The scoring criteria information file contains scoring criteria information as data in a text format such as a JSON format or an XML format. An example of preparing an answer paper for mathematics will be described below.

The scoring criteria information includes information such as “question name,” “answer type,” “model answer,” “scoring criteria” and “comments.” The “question name,” “answer type,” “model answer,” “scoring criteria” and “comments” can be stored for each question. If there are three questions, the “question name,” “answer type,” “model answer,” “scoring criteria” and “comments” can be stored three by three.

The “question name” is information representing the name of a question. The “question name” is uniquely assigned to each question in the same examination. The “question name” may be assigned by the first user entering a text or may be selected by the first user from among several alternatives.

The “answer type” is information of a type of sticky note that can be used to answer the corresponding question. When the “answer type” is “a mathematical expression” in a mathematical question, it is set such that a sticky note other than a mathematical expression sticky note cannot be used to answer the corresponding question.

The “model answer” is information of a model answer as one of information items of evaluation items assumed by the first user such as a teacher. When the answer of the second user such as a student matches the model answer described in the “model answer,” the answer is determined to be a correct answer.

The “scoring criteria” is information on evaluation items that serve as a criterion for automatic scoring. Specifically, the “scoring criteria” is information on evaluation items such as how many scores are given to the second user such as a student as reference scores when the answer of the second user matches the model answer, how many scores are deducted from the reference scores when the answer does not match the model answer but is mathematically equivalent, and how many scores are added when the answer does not match the model answer and is not mathematically equivalent, and can freely be described by the first user such as a teacher. “Mathematically equivalent” means that the answer is equivalent to the model answer even if it differs from the model answer only in its expression form, and indicates that the answer matches any evaluation item other than the model answer. For example, when the model answer is in the decimal format of “0.25” and the second user's answer is in the fractional format of “¼,” the latter answer is determined to be “mathematically equivalent” to the former answer. The “scoring criteria” may be described, for example, by combining an evaluation expression and a variable for evaluating whether an answer defined in advance in a web application is mathematically equivalent to the model answer. In addition, exclusion conditions may be described as the “scoring criteria.” An answer that meets the exclusion conditions may be determined to be neither identical nor mathematically equivalent to the model answer. The format of information described in the “scoring criteria” is not limited to a specific one as long as the format can be used for automatic scoring in the server 10.

The “comments” are text information of comments added by a teacher and the like. The entry of “comments” may be omitted.

The process of FIG. 3 is started when the terminal 20a requests the server 10 to start a web application. When the request is made, a login process such as entry of an ID and a password may be performed. Upon receipt of the request, the server 10 sends a program of the web application including data of the initial screen to the terminal 20a. Upon receipt of the program, the terminal 20a displays the initial screen on the web browser. In the initial screen, no paper 100 is prepared, but only a new paper preparation icon 100c and an answer paper preparation button 100d are displayed in the upper stage area 100a. Note that the process shown in FIG. 3 is performed in cooperation between the CPU 21 of the terminal 20a and the processor 11 of the server 10.

In step S1, the first user such as a teacher who is preparing an answer paper operates the input device 25 of the terminal 20a to select the new paper preparation icon 100c. In step S2, the terminal 20a transmits a request to prepare new paper 100 to the server 10. In step S3, the server 10 prepares new paper 100 and transmits it to the terminal 20a.

In step S4, the first user performs an operation of adding a sticky note as required. This operation may be, for example, an operation of selecting a sticky note additional icon (not shown) displayed on the new paper 100 or an operation of selecting a sticky note additional item from the menu displayed by right clicking the mouse. After adding the sticky note, the first user enters a supplementary comment or the like of the question in the sticky note as necessary. In step S5, the terminal 20a transmits the sticky note information, which is input by the first user, to the server 10. The server 10 associates the information of the sticky note with the paper 100. The sticky note information includes, for example, information such as positional information of the sticky note on the paper 100 and information such as text written onto the sticky note. The process of steps S4 to S5 may be repeated until the first user selects an answer paper preparation button 100d in step S6.

In step S6, the first user finishes writing supplementary comments or the like onto the sticky note and then operates the input device 25 to select the answer paper preparation button 100d. In step S7, the terminal 20a transmits an answer paper preparation request to the server 10. In step S8, the server 10 generates a dialog for preparing an answer paper and transmits the generated dialog to the terminal 20a. The terminal 20a displays the received dialog on the paper 100.

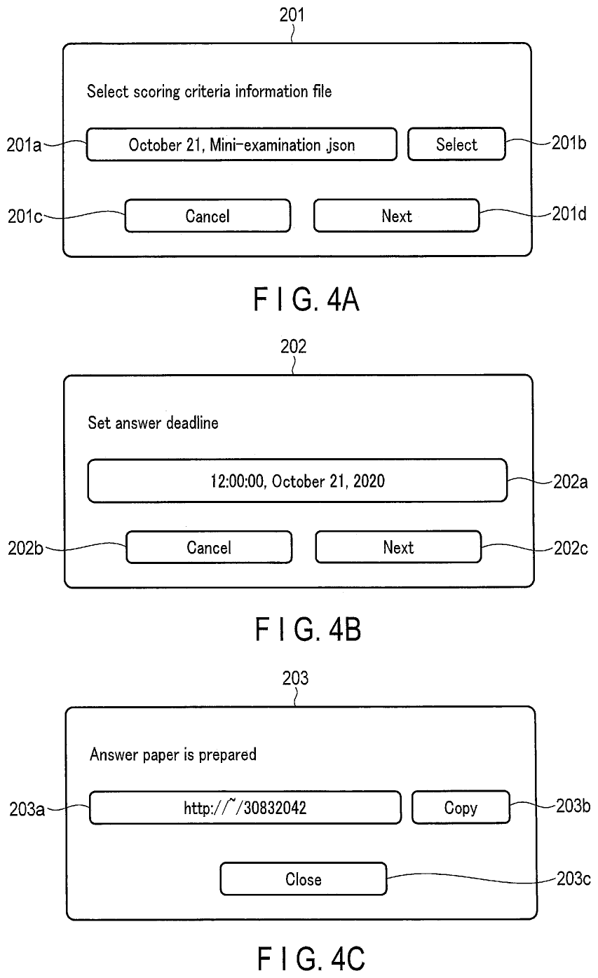

FIGS. 4A, 4B and 4C each show an example of a dialog displayed on the paper 100. First, a dialog 201 for selecting a scoring criteria information file shown in FIG. 4A is transmitted from the server 10 to the terminal 20a. The dialog 201 includes a file name display field 201a, a selection button 201b, a cancel button 201c and a “Next” button 201d. The file name display field 201a is a display field in which the name of the currently selected scoring criteria information file. The selection button 201b is a button for accepting an operation of displaying a selected screen of the scoring criteria information file. When the selection button 201b is selected, for example, a list of scoring criteria information files stored in the server 10 is displayed. When the first user selects a desired scoring criteria information file, the name of the selected scoring criteria information file is displayed in the file name display field 201a. The cancel button 201c is a button for accepting an operation of canceling the selection of a scoring criteria information file. When the cancel button 201c is selected, the selection of a scoring criteria information file is canceled, and the display of the dialog 201 is also terminated. The “Next” button 201d is a button for accepting an operation for determining the selection of a scoring criteria information file.

In step S9, the first user sets a scoring criteria. Specifically, the first user selects a scoring criteria information file in the dialog 201. After that, the first user selects the “Next” button 201d. In step S10, the terminal 20a transmits to the server 10 information of the selected scoring criteria information file such as the name of the scoring criteria information file. In step S11, the server 10 adds scoring criteria information to the paper 100 based on the information of the selected scoring criteria information file. Specifically, the server 10 associates the scoring criteria information file selected by the first user with the paper 100. After that, the server 10 transmits a dialog for the next setting to the terminal 20a. The terminal 20a displays the received dialog on the paper 100.

The server 10 transmits a dialog 202 for setting an answer deadline shown in FIG. 4B to the terminal 20a. The dialog 202 includes an answer deadline display field 202a, a cancel button 202b and a “Next” button 202c. The answer deadline display field 202a is a display field in which the currently set answer deadline is displayed. The first user can select the answer deadline display field 202a to set the answer deadline including units of hours, minutes and seconds. The answer deadline may be set, for example, by entering text or selecting from a calendar or the like. The cancel button 202b is a button for accepting an operation of canceling the setting of the answer deadline. When the cancel button 202b is selected, the setting of the answer deadline is canceled and the display of the dialog 202 is also terminated. In this case, the selection of the scoring criteria information file may also be canceled. The “Next” button 202c is a button for accepting an operation of determining the setting of the answer deadline.

In step S12, the first user sets the answer deadline in the dialog 202. After that, the first user selects the “Next” button 202c. In step S13, the terminal 20a transmits information of the set answer deadline information to the server 10. In step S14, the server 10 adds the information of the answer deadline to the paper 100. Specifically, the server 10 associates the information of the answer deadline with the paper 100. After that, the server 10 generates a URL unique to each paper 100. Then, the server 10 transmits a dialog containing the generated URL to the terminal 20a. The terminal 20a displays the received dialog on the paper 100.

The server 10 transmits to the terminal 20a a dialog 203 for notifying the terminal 20a of the completion of preparation of the answer paper shown in FIG. 4C. The dialog 203 includes a URL display field 203a, a copy button 203b and a close button 203c. The URL display field 203a is a URL for gaining access to the answer paper. The copy button 203b is a button for copying a character string representing the URL displayed in the URL display field 203a. The character string copied by the copy button 203b can be pasted to, for example, electronic mail. The electronic mail notifies the second user such as a student of the URL. The close button 203c is a button for accepting an operation of closing the dialog 203.

In step S15, the first user confirms the URL, copies the URL as necessary, and distributes electronic mail to the terminal 20b of the corresponding second user. The electronic mail may be distributed by the server 10. After these processes, the first user selects the close button 203c. In step S16, the terminal 20a transmits to the server 10 a notification of the end of the process of preparing the answer paper. Thus, the server 10 recognizes the end of the process. Upon completion of the process, the display of the paper 100 on the terminal 20a may be ended.

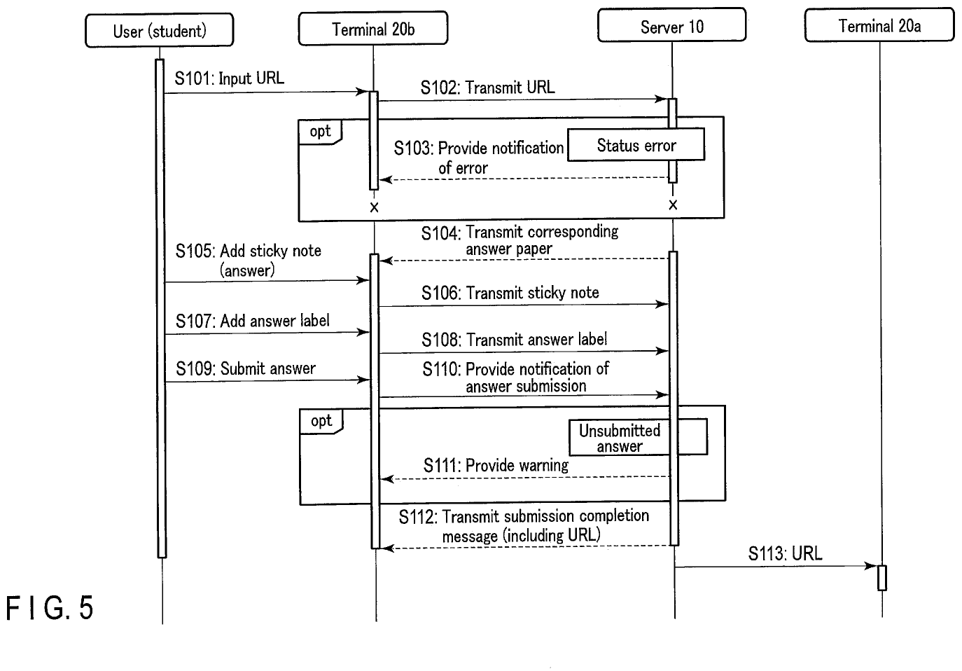

FIG. 5 is a sequence chart showing an example of the operation of the system 1 performed when a question is answered. The process shown in FIG. 5 is started when the web browser is started by the terminal 20b. This process is mainly performed by cooperation between the CPU 21 of the terminal 20b and the processor 11 of the server 10.

In step S101, the second user such as a student operates the terminal 20b to supply the web browser with the URL designated in advance by the first user such as a teacher via email or the like. In step S102, the terminal 20b gains access to the server 10 according to the URL. Note that a login process such as input of an ID and a password may be performed to gain access to the URL.

The server 10 determines whether the status of paper of the URL is a status error. For example, the server 10 determines whether the answer deadline set in the paper of the URL has expired. The server 10 also determines whether the submission status of the second user to the paper of the URL is “submitted.” As will be described later, when the second user answers a question and “submits” the answer, the server 10 sets the submission status of the second user from “not submitted” to “submitted.” The server 10 determines the submission status of the second user who has gained access to the server 10. When the answer deadline has expired or when the submission status of the second user is “submitted,” the server 10 determines that the status of paper of the URL is a status error. If the server 10 determines the status as a status error, it notifies the terminal 20b of the error in step S103, and then terminates the process. This error includes, for example, a message indicating that no answer can be made to the paper of the URL. On the other hand, when the answer deadline has not expired and the submission status of the second user is “not submitted,” the server 10 determines that the status of paper of the URL is not a status error. If the server 10 determines that it is not a status error, it transmits the paper of the URL to the terminal 20b in step S104. The terminal 20b displays the paper on the web browser.

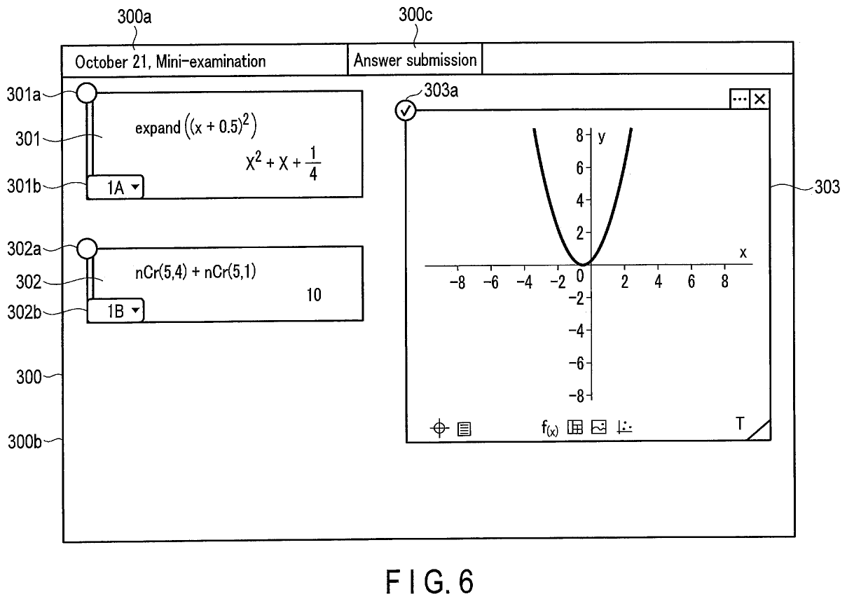

FIG. 6 is a diagram showing an example of a display screen of the terminal 20b on which an answer paper 300 is displayed. As in FIG. 2, the screen displayed on the display 26 of the terminal 20b includes an upper stage area 300a and a lower stage area 300b. The upper stage area 300a corresponds to the upper stage area 100a and the lower stage area 300b corresponds to the lower stage area 100b. When the answer paper 300 is displayed, an answer submission button 300c is displayed in the upper stage area 300a.

The second user can add a sticky note for each question to the answer paper 300. The second user can prepare a sticky note for the answer when a question is answered. In FIG. 6, three sticky notes 301, 302 and 303 are displayed. That is, in FIG. 6, the second user has prepared three sticky notes. The sticky notes 301, 302 and 303 can be selected by the second user from among the foregoing mathematical, graph, table and figure sticky notes.

The user can perform various input operations corresponding to the added sticky note, such as preparing a numerical expression, preparing a graph, preparing a table and preparing a figure. The user can also cause the server 10 to execute the calculation of a numerical expression. The result of the calculation of the numerical expression is displayed as the answer to a question, for example, at the lower right of the sticky note. In addition, the sticky notes 301, 302 and 303 include check columns 301a, 302a and 303a. For example, when the sticky note 303 is selected, a checkmark is displayed in the corresponding check column 303a. Not only a checkmark is displayed, but a sticky note that is selected and a sticky note that is not selected may be distinguished by another display method or the like. Each sticky note may be provided with an answer label. When the second user selects a drop-down list provided in an answer, a list of question names available for the corresponding sticky note is displayed. The second user selects a desired question name from the list and thus the sticky note is provided with an answer label. In the example shown in FIG. 6, the sticky note 301 is provided with an answer label 301b and the sticky note 302 is provided with an answer label 302b. In the list of question names, question names of answer types that do not match the sticky note prepared by the second user are not displayed. With respect to the numerical expression sticky note, for example, only the question names for which the answer type is set to a numerical expression are displayed in the list. Therefore, the sticky note 303 cannot be provided with a question name in which the answer type is set to a numerical expression.

In step S105, the second user adds a sticky note to the paper 300 to answer a question. In step S106, the terminal 20b transmits the added sticky note information to the server 10. The server 10 associates information of the sticky note with the paper 300 for each second user. The sticky note information includes, for example, identification information and positional information of each sticky note on the paper 300 and information of an answer entered in the sticky note. In step S107, the second user provides an answer label for the sticky note. In step S108, the terminal 20b transmits information of an answer label to the server 10. The server 10 associates information of the answer label with information of the sticky note for each second user. The information of the answer label includes, for example, information of a question name represented by the answer label. The process of steps S105 to S108 may be repeated until the second user selects the answer submission button 300c in step S109.

The second user prepares a sticky note, writes an answer, and provides the sticky note with an answer label. In step 109 that is a desired timing of submission of the answer, the second user selects the answer submission button 300c. In step S110, the terminal 20b transmits to the server 10 a notification that an answer is submitted.

The server 10 determines whether there is an unanswered question by totaling the information of answer labels associated with the paper 300 indicating that the answer is submitted. When the server 10 has determined that there is an unanswered question, it transmits a warning dialog to the terminal 20b in step S111. The warning dialog includes, for example, a message for confirming whether the submission process can be continued even though there is an unsubmitted answer. The warning dialog may also include a button for accepting an operation to continue submitting an answer and a button for accepting an operation to cancel submitting an answer. In this case, the server 10 may determine whether to continue or cancel the process of submitting an answer according to a button selected by the operation of the input device 25 of the second user. When the server 10 has determined that the answer submission process is to be continued, the process proceeds to step S112. If it has determined that the answer submission process is canceled, the process returns to step S105. If it has determined that there is no unanswered question, the process proceeds to step S112.

In step S112, the server 10 changes a submission status of the second user who is the user of the terminal 20b requesting the submission of the answer to the paper 300 to “Submitted.” Then, the server 10 generates a URL unique to each second user associated with the paper 300 that has been submitted. Then, the server 10 transmits a dialog containing the generated URL to the terminal 20b. The terminal 20b displays the received dialog on the paper 300. Note that the dialog displayed on the terminal 20b in the process of step S112 is similar to the dialog shown in FIG. 4C, and may be different from the dialog only in that the displayed message indicates the completion of the submission of the answer. The second user can confirm the paper 300 that he or she answered, using the URL transmitted in step S112. However, the second user is restricted so as not to be able to edit the paper 300 that is answered by the second user.

In step S113, the server 10 copies the URL and distributes electronic mail to the terminal 20a of the first user. The first user can confirm the paper 300 answered by the second user, using the URL transmitted in step 113, for example, for scoring.

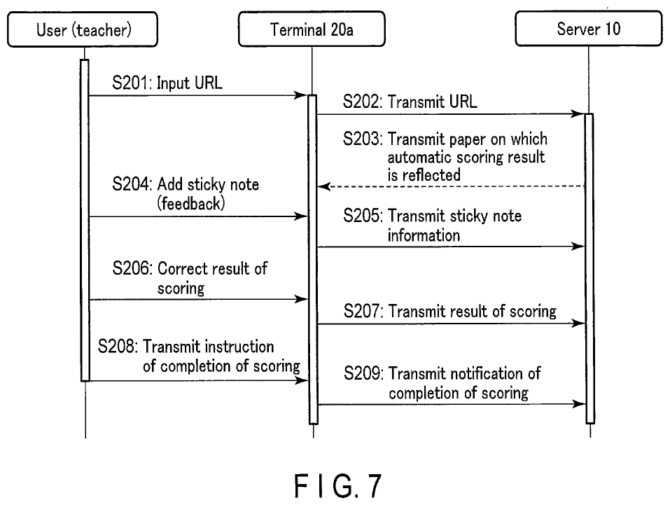

FIG. 7 is a sequence chart showing an example of an operation performed when scoring is made. The process shown in FIG. 7 is started when the web browser is started by the terminal 20a. The process is mainly performed by cooperation between the CPU 21 of the terminal 20a and the processor 11 of the server 10.

In step S201, the first user such as a teacher operates the terminal 20a to supply the web browser with the URL designated in advance from the server 10 via email or the like. In step S202, the terminal 20a gains access to the server 10 according to the URL. Note that a login process such as input of an ID and a password may be performed to gain access to the URL.

In step S202, the server 10 calls the paper 300 of the input URL. Then, the server 10 extracts the second user's answer from the information of a sticky note associated with the paper 300. After that, the server 10 compares the second user's answer with the scoring criteria information associated with the paper 300 to make automatic scoring. When the automatic scoring is completed, the server 10 transmits paper including the result of the automatic scoring to the terminal 20a. The terminal 20a displays the received paper on the web browser.

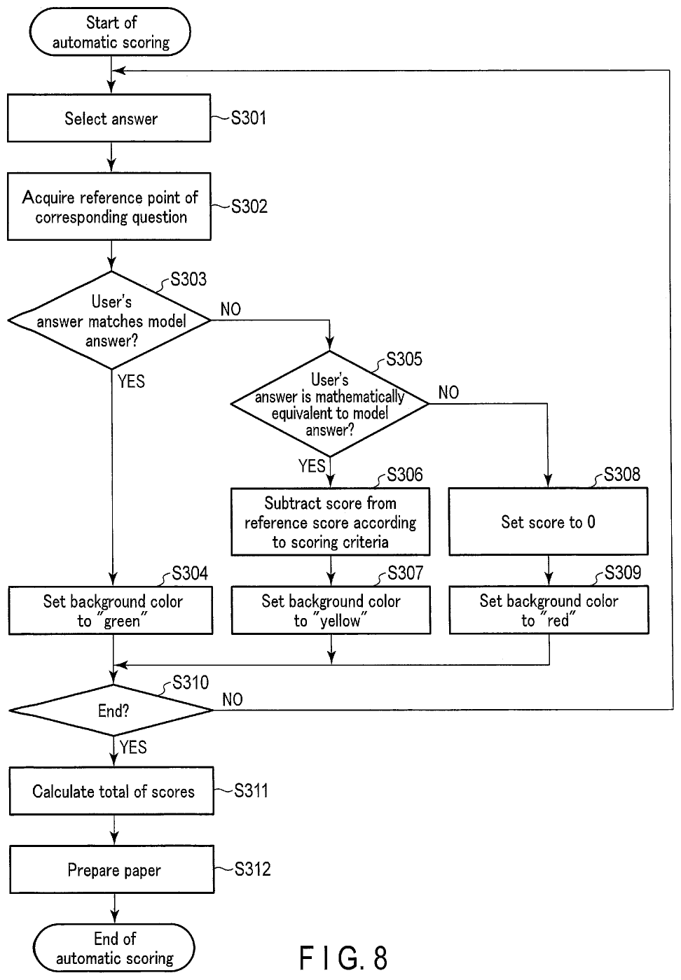

FIG. 8 is a flowchart showing an example of the process of the server 10 performed when automatic scoring is made. In step S301, the server 10 selects one answer in accordance with the order of question labels. When there is a blank question label in the question labels, the server 10 sets the score for the blank question label to 0.

In step S302, the server 10 acquires a question name of a question label and a reference score corresponding to the question name from the scoring criteria information, and gives the reference score to the second user's score in the question label. As described above, the reference score is a score given when the second user's answer is correct.

In step S303, the server 10 determines whether the selected second user's answer matches a model answer in the corresponding question name. When the server 10 determines in step S303 that the second user's answer matches the model answer, the process proceeds to step S304. If it is determined in step S303 that the answer by the second user does not match the exemplary answer, the process proceeds to step S305.

In step S304, the server 10 sets the background color of a sticky note of the corresponding question label to “green.” The process proceeds to step S310. The background color is the background color of a sticky note included in the paper displayed in the terminal 20a as a result of the automatic scoring. The background color is changed according to the result of the automatic scoring based on the scoring criteria information. That is, when the second user's answer matches the model answer, the background color is set to “green.” Note that the reference score is given as the second user's score of the corresponding question label.

In step S305, based on the scoring criteria information, the server 10 determines whether the second user's answer is mathematically equivalent to the model answer. In step S305, when the second user's answer matches the exclusion conditions described in the scoring criteria information, the server 10 may determine that the second user's answer is not mathematically equivalent to the model answer. In step S305, when the server 10 determines that the second user's answer is mathematically equivalent to the model answer, the process proceeds to step S306. In step S305, when the server 10 determines that the second user's answer is not mathematically equivalent to the model answer, the process proceeds to step S308.

In step S306, the server 10 subtracts the score of the corresponding question label from the reference score according to the evaluation items of the scoring criteria.

In step S307, the server 10 sets the background color of a sticky note of the corresponding question label to “yellow.” After that, the process proceeds to step S310. That is, when the second user's answer does not match the model answer but is mathematically equivalent thereto, the background color is set to “yellow.”

In step S308, the server 10 sets the score of the corresponding question label to 0. In step S308, the server 10 may add scores from 0 depending on the evaluation items of the scoring criteria.

In step S309, the server 10 sets the background color of a sticky note of the corresponding question label to “red.” After that, the process proceeds to step S310. That is, when the second user's answer is wrong, the background color is set to “red.”

In step S310, the server 10 determines whether to end the automatic scoring. For example, when the scoring for all the question labels is completed, the server determines that the automatic scoring is ended. When the server 10 determines in step S310 that the automatic scoring is not ended, the process returns to step S301. When the server 10 determines in step S310 that the automatic scoring is ended, the process proceeds to step S311.

In step S311, the server 10 calculates the total of scores given for each question label.

In step S312, the server 10 prepares paper of results of the automatic scoring. Then, the server 10 ends the process of FIG. 8.

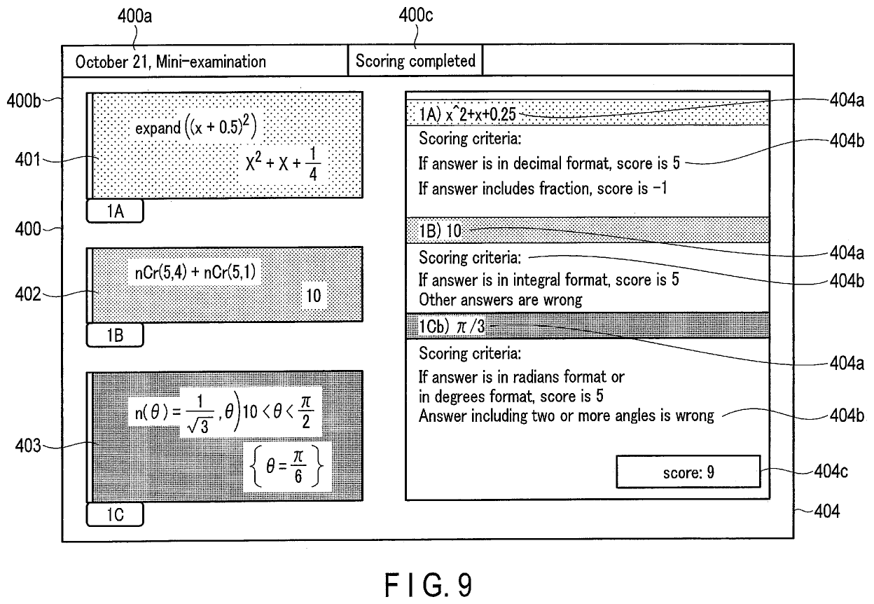

FIG. 9 is a diagram showing an example of the display screen of the terminal 20a on which paper 400 of automatic scoring results is displayed. The screen displayed on the display 26 of the terminal 20a includes an upper stage area 400a and a lower stage area 400b. The upper stage area 400a corresponds to the upper stage area 100a, and the lower stage area 400b corresponds to the lower stage area 100b. When the paper 400 of the automatic scoring results is displayed, a scoring completion button 400c is displayed in the upper stage area 400a.

On the paper 400 of the automatic scoring results, sticky notes for answers added to the answer paper 300 by the user and their corresponding sticky notes are displayed. In FIG. 9, three sticky notes 401, 402 and 403 are displayed. The contents displayed on these sticky notes 401, 402 and 403 are the same as those of the sticky notes added to the answer paper 300. However, unlike the contents of the sticky notes for answers, the contents of the sticky notes 401, 402 and 403 cannot be edited.

A background color is set for each of the sticky notes 401, 402 and 403. The background color is set according to the result of automatic scoring. As described above, the “green” background color is set to the sticky notes when the answer matches the model answer, the “yellow” background color is set thereto when the answer does not match the model answer but is mathematically equivalent to the model answer, and the “red” background color is set thereto when the answer does not match the model answer or is not mathematically equivalent thereto. FIG. 9 shows an example in which the background color of the sticky note 401 is “yellow,” the background color of the sticky note 402 is “green” and the background color of the sticky note 403 is “red.”

In addition, a scoring criteria sticky note 404 is displayed on the paper 400 of the result of automatic scoring. The scoring criteria sticky note 404 is a list of evaluation items of the scoring criteria to each of the questions associated with the corresponding answer paper 300.

The scoring criteria sticky note 404 includes a model answer 404a, an evaluation item 404b and a total score 404c. The model answer 404a is a “model answer” recorded in the scoring criteria information about the corresponding question. The evaluation item 404b is a text representing each of the evaluation items of the “scoring criteria” recorded in the scoring criteria information about the corresponding question. The total score 404c are the total scores for each question calculated as a result of the automatic scoring. The numerical value displayed at the total score 404c can be corrected by the first user.

In the scoring criteria sticky note 404, the field of the model answer 404a is colored according to the result of the automatic scoring. For example, when the answer matches the model answer, the field of the model answer 404a is colored “green.” If the answer does not match the model answer but is mathematically equivalent to the model answer, the field of the model answer 404a is colored “yellow.” For example, if the answer matches an evaluation item other than the model answer, it is determined to be mathematically equivalent thereto. If the answer does not match the model answer or is not mathematically equivalent thereto, the field of the model answer 404a is colored “red.” That is, the field of the model answer 404a is colored in the same color as the background color of each of the sticky notes 401, 402 and 403. Note that the color scheme shown here is an example and may be changed as appropriate.

Let us now return to FIG. 7. In step S204 after the paper 400 shown in FIG. 9 is displayed on the terminal 20a, the first user performs an operation of adding a sticky note as necessary. After that, the first user enters a feedback comment or the like to the sticky note as necessary. In step S205, the terminal 20a transmits to the server 10 information of the sticky note input by the first user. The server 10 associates the sticky note information with the paper 400. The sticky note information includes, for example, positional information of the sticky note on the paper 400 and information such as text written onto the sticky note. In step S206, the first user corrects the total score 404c when the result of the automatic scoring is not desired by the first user. In step S207, the terminal 20a transmits to the server 10 information of the total score corrected by the first user. The server 10 corrects the user's total score information associated with the paper 300. The process of steps S204 and S205 may be repeated until the first user selects the scoring completion button 400c in step S206.

The first user selects the scoring completion button 400c in step S208 when the scoring result is desired by the first user. In step S209, the terminal 20a transmits a notification of completion of the scoring to the server 10. Accordingly, the server 10 recognizes the end of the process. Upon completion of the process, the display of the paper 400 on the terminal 20a may be ended. The paper 400 for which scoring is completed may be set so as not to be edited.

As described above, according to the present embodiment, the answers submitted by the second user such as a student are automatically scored according to the scoring criteria information including predetermined evaluation items. As a result of the automatic scoring, in accordance with which of the evaluation items the answers match, an answer which matches the model answer, an answer which does not match the model answer but is substantially equivalent to the model answer, and an answer which does not match the model answer and is not substantially equivalent thereto are displayed separately from one another. Thus, the first user such as a teacher can intuitively recognize a type of scoring criteria based on which the automatic scoring for each question is performed. In particular, questions colored “yellow” are scored based on evaluation items prepared in advance based on the first user's idea of scoring, rather than on an absolute criteria of whether or not the answers to the questions match the model answers. Thus, the first user has only to check mainly the questions colored “yellow.” Therefore, the first user's burden of confirming the result of automatic scoring by visual observation is reduced and so is the error of the confirmation, with the result that the quality of automatic scoring is improved.

[Modification]

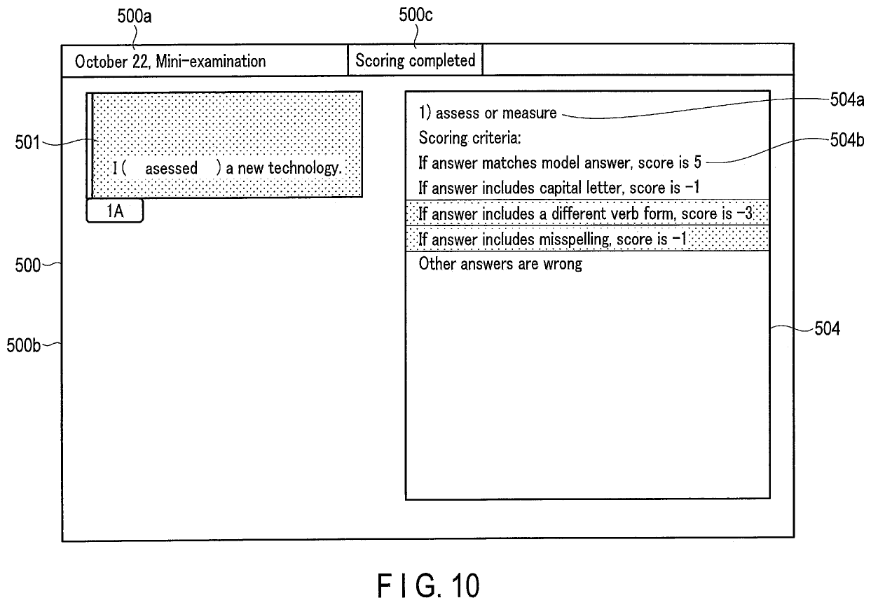

A modification to the embodiment will be described below. The embodiment is directed to an example of automatic scoring for answers to mathematics questions. In contrast, the method of the modification may be applied to automatic scoring for answers to various types of question other than mathematics questions. FIG. 10 is a diagram showing an example of a display screen of the terminal 20a on which paper 500 of automatic scoring results for an English examination is displayed. The screen displayed on the display 26 of the terminal 20a also includes an upper stage area 500a and a lower stage area 500b. The upper stage area 500a corresponds to the upper stage area 100a and the lower stage area 500b corresponds to the lower stage area 100b. When the paper 500 of the automatic scoring results is displayed, a scoring completion button 500c is displayed in the upper stage area 500a. These are similar to the paper 400.

On the paper 500 of the automatic scoring results, an answer sticky note added to the answer paper 300 by the user and its corresponding sticky note are displayed. FIG. 10 shows one sticky note 501. This sticky note corresponds to the sticky notes 401, 402 and 403 of the paper 400. FIG. 10 shows a question to which a semantically correct word should be written in parentheses as an answer.

The background color of the sticky note 501 is set according to the result of automatic scoring. For example, the background color of “green” is set to a sticky note when the answer matches the model answer, the background color of “yellow” is set to a sticky note when the answer semantically matches the model answer but has a problem in the expression form, and the background color of “red” is set to a sticky note when the answer does not semantically match the model answer. The problem in the expression form is answers including errors, though the answers are assumed to have the same meaning as the model answers, such as “words to be written in small letter contain capital letters,” “verbs have different forms” and “words contain misspellings” as shown in FIG. 10.

In the modification, the field of an evaluation item that has matched an answer is colored. For example, FIG. 10 shows an example in which whereas the word “assess” or “measure” is a model answer, the answer contains a spelling error such as “asessed” and the answer is written in the past tense. In this case, the fields of the evaluation items “score is −3 if the verb form is different” and “score is −1 if there is a spelling error” are colored “yellow.” This coloring makes it possible for the first user to more intuitively recognize a type of a scoring criteria based on which scoring is performed. The coloring for each evaluation item may be performed in the example of FIG. 9 described above. In addition, when a plurality of evaluation items are colored as shown in FIG. 10, different colors may be applied to the evaluation items.

In the embodiment, the server 10 performs automatic scoring according to the scoring criteria prepared by the first user and colors the answers according to the results of the automatic scoring. On the other hand, the server 10 may perform automatic scoring by, for example, artificial intelligence that have learned the scoring criteria prepared by the first user. In this case, too, the server 10 differentially displays the answers on the display according to the automatic scoring results.

Also, in the embodiment, the background colors of sticky notes vary among an answer that matches the model answer, an answer that does not match the model answer but is substantially equivalent thereto, and an answer that does not match the model answer or is not substantially equivalent thereto. However, these answers have only to be displayed so as to be distinguished visually by the first user. For example, the display may be made to change the shape of the frame of a sticky tag, to change the color of the frame, or to change the thickness of the frame.

Also, in the embodiment, the background colors of sticky notes vary among an answer that matches the model answer, an answer that does not match the model answer but is substantially equivalent thereto, and an answer that does not match the model answer or is not substantially equivalent thereto. In contrast, the background color of a sticky note may be colored only for the answer that does not match the model answer but is substantially equivalent thereto.

The present disclosure is not limited to the embodiment or modification described above, but their structural elements can be modified in different ways without departing from the spirit of the invention when the disclosure is reduced to practice. The embodiment and modification can possibly be combined as appropriate, and an advantageous effect can be obtained from the combination. The embodiment includes inventions in various stages, and various inventions can be extracted from appropriate combinations of structural elements of the embodiment. Even though some of the structural elements are deleted from the embodiment, if the problem is to be solved by the invention and the advantageous effects are obtained, a configuration from which the structural elements are deleted can be extracted as an invention.

1. An automatic scoring method by processor comprising:
receiving information including an answer to a question;
scoring the answer according to one or more evaluation items preset for the question; and
visually distinguishing a result of the scoring in accordance with an evaluation item that has matched the answer.

2. The automatic scoring method of claim 1, wherein:
the evaluation items include a model answer to the answer; and
the distinguishing includes distinguishing an answer which matches the model answer, an answer which does not match the model answer but is equivalent thereto, and an answer which does not match the model answer or is not equivalent thereto from one another.

3. The automatic scoring method of claim 1, wherein:
the evaluation items include a model answer to the answer; and
the distinguishing includes distinguishing only an answer which does not match the model answer but is equivalent thereto.

4. The automatic scoring method of claim 1, wherein the distinguishing includes distinguishing a field on the display where the answer is displayed.

5. The automatic scoring method of claim 1, wherein the distinguishing includes distinguishing a field of an evaluation item on the display which matches the answer is displayed.

6. The automatic scoring method of claim 1, wherein the distinguishing includes coloring the results of the scoring in accordance with evaluation item that has matched the answer.

7. A server that is communicable with a terminal, comprising a processor configured to:
receive information including an answer to a question;
score the answer according to one or more evaluation items preset for the question;
visually distinguish a result of the scoring in accordance with an evaluation item that has matched the answer; and
transmit the result of the scoring to the terminal.

8. An automatic scoring system comprising:
a server including a first processor configured to:
receive information including an answer to a question;
score the answer according to one or more evaluation items preset for the question;
visually distinguish a result of the scoring on a display in accordance with an evaluation item that has matched the answer; and
transmit the result of the scoring; and
a terminal including a second processor configured to:
receive the result of the scoring from the server; and
displaying the received result of the scoring on a display.

9. A non-transitory recording medium which records programs to cause a processor to:
receive information including an answer to a question;
score the answer according to one or more evaluation items preset for the question; and
visually distinguish a result of the scoring on in accordance with an evaluation item that has matched the answer.
